(19) United States
(12) Patent Application Publication
(10) Pub. No.: US 2010/0031007 A1
(43) Pub. Date: Feb. 4, 2010

(54) METHOD TO ACCELERATE NULL-TERMINATED STRING OPERATIONS

(75) Inventor: Mayan MOUDGILL, White Plains, NY (US)

Correspondence Address: BARNES & THORNBURG LLP, 750-17TH STREET NW, SUITE 900, WASHINGTON, DC, 20006-4675, US

(73) Assignee: SANDBRIDGE TECHNOLOGIES, INC., Tarrytown, NY (US)

(21) Appl. No.: 12/365,130

(22) Filed: Feb. 3, 2009

Related U.S. Application Data
(60) Provisional application No. 61/029,422, filed on Feb. 18, 2008.

(51) Int. Cl. G06F 9/30

(52) U.S. Cl. 712/220; 712/E09.016

(57) ABSTRACT

A method reads and compares first and second register values, each with a size of at least two bytes. A third register indicates a match if: (1) a byte in the first register value is equal to (or, alternatively, not equal to) a corresponding byte in the second register value, or (2) if a byte in the first register value is zero. Next, a fourth register value is set to one of the following: (1) a count of the matching byte, if the corresponding bytes in the first and second register values are equal (or, alternatively, are not equal), or (2) a number outside of a range between 0 and n−1, if the corresponding bytes in the first and second register values are not equal (or, alternatively, are equal). The value, n, is an integer equal to the number of bytes in the first and second register values.

### CROSS-REFERENCE TO RELATED APPLICATION(S)

This is a United States Non-Provisional Patent Application that relies for priority on and claims priority to U.S. Provisional Patent Application Ser. No. 61/029,422, filed on Feb. 18, 2008, the contents of which are incorporated herein by reference.

### FIELD OF THE INVENTION

As should be appreciated by those skilled in the art, some programming languages, including C and C++, produce null-terminated byte strings. The invention capitalizes on this characteristic of C and C++ programming languages by proposing a family of instructions to accelerate processing of standard string functions.

### DESCRIPTION OF THE RELATED ART

As should be apparent to those skilled in the art, C and C++ programming languages produce standard strings, which are null terminated. A null-terminated byte string is one where the end of string is indicated with a 0 byte.

When processing strings, the performance of certain key kernels may determine the performance of the overall application. These functions are generally the ones defined in the standard library (specifically, section 7.21 of the ISO C standard), such as: (1) the strlen function, (2) the strcmp function, (3) the strcpy function, and (4) the strchr function.

The execution of any of these functions may require an appreciable amount of processor time. Accordingly, methods that help to reduce the processing time are desired in the art.

### SUMMARY OF THE INVENTION

The invention offers at least two methods to reduce the overall processing time for certain instructions.

Specifically, the invention is based, at least in part, upon the null-termination of selected byte strings generated by C and C++ programming languages, among others.

The invention proposes a minimal set of instructions that allow for an acceleration of these functions because of the null-terminated strings. In other words, one aspect of the invention recognizes the existence of and takes advantage of the null-terminated strings. In so doing, the invention increases processing speed and efficiency.

In one proposed set of instructions for the invention, the invention provides for a method that includes reading first and second register values, both of which are at least two bytes in length. In this method, the first and second register values have the same number of bytes. As a result, comparing the bytes of the first register value with the bytes of the second register value is a simple task. After comparing the first and second register values, the method sets a third register to indicate a match if: (1) a byte in the first register value is equal to a corresponding byte in the second register value, or (2) if a byte in the first register value is zero. In addition, the method sets a fourth register value to (1) a count of the matching byte, if the byte in the first register value is equal to the corresponding byte in the second register value, or (2) a number outside of a range of values comprising numbers between 0 and n−1, if the byte in the first register value is not equal to the corresponding byte in the second register value. As should be apparent, n is an integer corresponding to the number of bytes in the first and second register values.

In an alternative to this method, the invention also provides for a method where first and second register values, both being at least two bytes in length, are read. As in the first instance, the first and second register values are contemplated to be the same length. The bytes of the first register value area compared with the bytes of the second register value. A third register is set to indicate a match if: (1) a byte in the first register value is not equal to a corresponding byte in the second register value, or (2) if a byte in the first register value is zero. A fourth register value is set to (1) a count of the matching byte, if the byte in the first register value is not equal to the corresponding byte in the second register value, or (2) a number outside of a range of values comprising numbers between 0 and n−1, if the byte in the first register value is equal to the corresponding byte in the second register value. As before, n is an integer corresponding to the number of bytes in one of either the first and second registers.

The invention also provides for the bytes of the first register value and the second register value to be compared from the most significant byte to the least significant byte, if the processor is big-endian.

Another aspect of the invention provides for the bytes of the first register value and the second register value to be compared from the least significant byte to the most significant byte, if the processor is little-endian.

With respect to the third register, it is an aspect of the invention to provide the third register as a condition flag register with one bit.

The invention further provides for the third register being a condition register with more than one bit. In this instance, one of the several bits of the third register may be set to indicate the match.

Still another aspect of the invention provides that the third register may be a condition register comprising several bits. In this variation, the third register may retain different values depending on whether the byte in the first register value is equal to the corresponding byte in the second register value or the first byte in the first register value is zero.

With respect to the fourth register value, the invention allows that value to be set to −1, if the byte in the first register value is not equal to the corresponding byte in the second register value.

Another aspect of the invention provides for the third and fourth register values to be set simultaneously.

One further aspect of the invention provides for at least two separate registers to cooperate with the processor to execute the method.

Still another aspect of the invention contemplates that the processor may load into a register beginning with a predetermined byte boundary.

In another variation, the bytes of the first register value are compared with only the lowest bytes of the second register value.

In still one further variation, the invention includes modifying the third register if a match is not indicated.

In another aspect of the invention, the third register may be a condition flag register including one bit, which may be set when the match is indicated. Alternatively, the bit may be cleared when the match is not indicated.

One aspect of the invention provides a method where the third register is a condition flag register with one bit, which may be cleared when the match is indicated. Alternatively, the bit may be set when the match is indicated.

In another aspect of the invention, the third register may be a condition register with a plurality of bits. One of the plurality of bits may be set when the match is indicated or the bit may be cleared when the match is not indicated.

In yet another aspect of the invention, the third register may be a condition register with several bits. One of the several bits may be cleared when the match is indicated. Alternatively, the bit may be set when the match is not indicated.

Still further aspects of the invention will be made apparent from the discussion that follows.

### BRIEF DESCRIPTION OF THE DRAWINGS

The invention will now be described in connection with the drawings appended hereto, in which:

FIG. 1 is a first part of a first embodiment of a method of the invention;

FIG. 2 is the second part of the first embodiment of the method illustrated in FIG. 1;

FIG. 3 is a first part of a second embodiment of a method of the invention; and

FIG. 4 is the second part of the second embodiment of the method illustrated in FIG. 1.

### DESCRIPTION OF EMBODIMENT(S) OF THE INVENTION

The invention will now be described in connection with various contemplated embodiments. The embodiments are intended to be exemplary of the invention and not to place any limitations on the scope of the invention. Accordingly, as should be appreciated by those skilled in the art, there are numerous variations and equivalents that may be employed without departing from the scope and spirit of the invention. Each of those variations and equivalents also are intended to be encompassed by the scope of the invention.

For purposes of describing the invention, several assumptions have been made. First, it is assumed that instructions in the processor are capable of setting a register and a condition flag or a bit simultaneously. Second, it is assumed that instructions in the processor are capable of reading at least 2 separate registers. Third, it is assumed that the processor has multi-byte registers (such as a 32 bit register). Fourth, it is assumed that the processor may load into the register starting at any byte boundary. This fourth assumption is not necessary for the implementation of the invention. However, this fourth assumption greatly simplifies the description of the invention, as will be made apparent below.

For the invention, two instructions are proposed. The first instruction is called the ffzbe instruction. The second instruction is called the ffzbn instruction. The letters “ffzbe” are intended to refer to “find first zero or byte equal”. The letters “ffzbn” are intended to refer to “find first zero or byte not-equal”. Of course, the selection of the names for these instructions is not critical to the invention. Any other name may be selected without departing from the scope of the invention.

The ffzbe Instruction

The ffzbe instruction includes the following operations: (1) two register values, RA and RB, are read, (2) a register value, RT, and a condition bit/flag are written, (3) the bytes RA and RB are examined from the most significant byte (“MSB”) to the least significant byte (“LSB”) or from the LSB to the MSB, depending on whether the processor is big-endian or little-endian, (4) if the value of a byte in RA is zero or equal to the corresponding byte of RB, a marker in the condition bit or flag is set to indicate a match, (5) if the first match is that of the equal bytes, then RT is set to the count of the matching byte, and (6) otherwise, the value of RT is set to be a value that is outside the range 0 . . . num_bytes_in_register−1. One such choice is −1.

The pseudo-C for this instruction is set forth in Code Segment #1, below. With respect to Code Segment #1, several assumptions have been made. First, it is assumed that the processor uses condition bits and that the instruction always sets/clears the condition bits to zero. Second, it is assumed that the register width is 4 bytes. Third, it is assumed that the processor is a big endian. With these assumptions, Code Segment #1 is presented below.

Code Segment #1

```
for(i=0; i<4; i++ ) {
  ba = (ra>>(8*i))&0xff; /* find the i-th byte */
  bb = (rb>>(8*i))&0xff;
  if( ba == bb ) {
    cbit0 = 1;
    rt = i;
  }
  else if( ba == 0 ) {
    cbit = 1;
    rt = −1;
  }
}
```

With Code Segment #1, it is relatively straight-forward to find the length of a zero terminated string (a strlen instruction/operation). In pseudo-assembler code, a non-optimized assembly version may be presented as detailed in Code Segment #2, below:

Code Segment # 2

| ;;; strlen: takes one argument | | | |
|---|---|---|---|
| ;;; | radr: | address of string | |
| strlen: | | | |
| | li | rz,0 | ; initialize RB to 0 |
| | li | rlen,0 | ; initialize length to 0 |
| loop: | | | |
| | ld | rval,radr,0 | ; load from radr |
| | ffzbe | rpos,rval,rz | ; check if any byte 0 |
| | jtrue | cb0,found | |
| | add | rlen,rlen,4 | ; bump length |
| | add | radr,radr,4 | ; bump address |
| found: | | | |
| | add | rlen,rlen,rpos | |
| | add | rlen,rlen,−1 | ; subtract one for the 0 byte |
| | return | rlen | |

As may be apparent to those skilled in the art, an optimized implementation of Code Segment #2 would be quite different from the non-optimized example detailed above. Among other things, the optimized implementation is contemplated to take advantage of more complex instructions such as a load-and-update instruction. Moreover, it is contemplated that the optimized version of Code Segment #2 would not keep a length field. Instead, it is contemplated that the optimized version of Code Segment #2 would rely on the difference between the original address and the last loaded address to compute the length.

As also may be appreciated by those skilled in the art, finding the position of a specific byte in a string (a strchr instruction/operation) may be accomplished fairly straight-forwardly. It is noted that the strchr operation returns a 0 if the character is not found. Otherwise, the operation returns a pointer to the character in the string. Code Segment #3 provides one example of this operation:

Code Segment #3

;;; strchr: takes two argument

| ;;; | radr: | address of string | |
|---|---|---|---|
| ;;; | rc: | byte being located | |
| | shl | rc2,rc,8 | |
| | or | rc2,rc2,rc | |
| | shl | rc4,rc2,16 | |
| | or | rc4,rc4,rc2 | |
| strchr: | | | |
| loop: | | | |
| | ld | rval,radr,0 | ; load from radr |
| | ffzbe | rpos,rval,rc4 | ; check if any byte 0 or rc |
| | jtrue | cb0,found | |
| | add | radr,radr,4 | ; bump address |
| found: | | | |
| | cmp | cb1,rpos,−1 | ; check if 0 found first |
| | jfalse | cb1,found_byte | |
| | return | 0 | ; 0 found first |
| found_byte: | | | |
| | add | radr,radr,rpos | |
| | return | radr | |

Finally, as may be appreciated by those skilled in the art, this instruction may be used to write an efficient string copy instruction (a.k.a., a strcpy instruction). An example of a strcpy instruction is provided below in Code Segment #4.

Code Segment #4

| ;;; strcpy: takes two argument | | | |
|---|---|---|---|
| ;;; | rdst: | address being written to | |
| ;;; | rsrc: | address of string | |
| strcpy: | | | |
| | li | rz,0 | |
| | cpy | rorig,rdst | ; original address of dest |
| loop: | | | |
| | ld | rval,rsrc,0 | ; load from radr |
| | ffzbe | rpos,rval,rz | ; check if any byte 0 or rc |
| | jtrue | cb0,found | |
| | st | rval,rdst,0 | ; copy value |
| | add | radr,radr,4 | ; bump addresses |
| | add | rdst,rdst,4 | |
| found: | | | |
| | stb | rval,rdst,0 | |
| | cmpe | cb1,rpos,0 | |
| | jtrue | done | |
| | shr | rval,rval,8 | |
| | stb | rval,rdst,1 | |
| | cmpe | cb1,rpos,1 | |
| | jtrue | done | |
| | shr | rval,rval,8 | |
| | stb | rval,rdst,2 | |
| | cmpe | cb1,rpos,2 | |
| | jtrue | done | |
| | shr | rval,rval,8 | |
| | stb | rval,rdst,3 | |
| ′ done: | | | |
| | return | rorig | |

As one might expect, Code Segment #4 may be optimized in several different ways. While details of the optimization are not provided here, it is noted that the code may be optimized particularly between the labels “found” and “done”, where the last few bytes of the string are copied.

The ffzbn Instruction

The ffzbn instruction includes the following operations: (1) two register values, RA and RB, are read, (2) a register value, RT, and a condition bit/flag are written, (3) the bytes of RA and RB are examined from the most-significant byte (“MSB”) to least significant byte (“LSB”) or from the LSB to the MSB, depending on whether the processor is big-endian or little-endian, (4) if the value of a byte in RA is zero or not-equal to the corresponding byte of RB, a marker in the condition bit or flag is set to indicate a match, (5) if the first match is that of the not-equal bytes, then RT is set to the count of the matching byte, and (6) otherwise, the value of RT is set to be a value that is outside the range 0 . . . num_bytes_in_register−1. One such choice would be −1.

The pseudo-C code for this instruction may be written as set forth in Code Segment #5, below. Code Segment #5 is based on several assumptions. First, it is assumed that the processor uses condition bits. Second, it is assumed that the instruction always sets/clears the condition bit to zero. Third, it is assumed that the register width is four bytes. Fourth, it is assumed that the processor is big endian. With these four assumptions, Code Segment #5 is presented as one example of the invention.

Code Segment #5

```
for(i=0; 1<4; i++ ) {
  ba = (ra>>(8*i))&0xff; /* find the i-th byte */
  bb = (rb>>(8*i))&0xff;
  if( ba != bb ) {
    cbit0 = 1;
    rt = i;
  }
  else if( ba == 0 ) {
    cbit = 1;
    rt = −1;
  }
}
```

The instruction presented in Code Segment #5 may be used to write an efficient string compare instruction, also referred to as “strcmp”. This instruction is presented as Code Segment #6, below.

Code Segment #6

| ;;; strcmp: takes two argument | | | |
|---|---|---|---|
| ;;; | rad0: | address of first string | |
| ;;; | rad1: | address of second string | |
| strcmp: | | | |
| loop: | | | |
| | ld | rv0,rad0,0 | ; load from strings |
| | ld | rv1,rad1,0 | |
| | ffzbn | rpos,rval,rz | ; check for 0 or != byte |
| | jtrue | cb0,found | |
| | add | rad0,rad0,4 | ; bump addresses |
| | add | rad1,rad1,4 | |
| found: | | | |
| | cmpe | cb1,rpos,−1 | |
| | jtrue | equal | |
| | mul | rpos8,rpos,8 | ; number of bits |
| | shl | rv0,rv0,rpos8 | |
| | shl | rv1,rv1,rpos8 | |
| | and | rv0,rv0,0xff | |
| | and | rv1,rv1,0xff | |
| | sub | rdif,rv0,rv1 | |
| | return | rdif | |
| equal: | | | |
| | return | 0 | |

Code Segment #6 is not written optimally. Optimizations should be apparent to those skilled in that art and, therefore, are not detailed herein.

### Additional Information

With reference to the ffzbe instruction and the ffzbn instruction, there are several variations that are contemplated as a part of the invention.

One variation contemplated for both of the instructions avoids a comparison against individual bytes of RB. In this variation, a comparison is made only against the lowest byte of RB. This particular variation, at least for the ffzbe instruction permits an implementation of the strchr instruction, without a need for copying at the head (or beginning) of the function. As may be appreciated by those skilled in the art, this reduces processing time and increases processing efficiency.

Another contemplated variation concerns a treatment of the condition bit/flag when the flag/bit does not need to be set. In this variation, there are several contemplated options. In one option, the flag/bit is set or cleared every time that the ffzbe instruction or the ffzbn instruction is executed. In a second option, the condition flag/bit is set as specified above when (1) a zero byte is encountered or (2) when equal and/or non-equal bytes are encountered. In this option, if these conditions are not satisfied, the condition flag is left untouched.

Yet another variation is contemplated when the processor uses condition flags that signal multiple conditions. Conditions include, but are not limited to, (1) greater than, (2) less than, (3) equal to, or combinations of these three conditions. The presence of multiple flags permits the instruction to distinguish between the zero-byte match case and the equal/not-equal match cases by setting different flags. Further, the ffzbn instruction may also compare the first unequal bytes and set the greater-than/less-than flags depending on ba>bb or ba<bb, according to the pseudo-C descriptions provided above.

Aspects similar to those of the invention may be found in the prior art. The closest example is, perhaps, the Power PC 440's dlmbz instruction. This instruction searches an 8-byte value formed by concatenating two registers for the first byte which is 0. It may be said that this has the functionality of the ffzbe instruction with rb=0, thereby permitting it to be used for strcpy and strlen. However, the dlmbz instruction does not accelerate functions such as strcmp and strchr, among other deficiencies, as should be apparent to those skilled in the art.

As the foregoing has made apparent, the invention presents a variety of different embodiments and variations, which are summarized below and discussed in connection with the drawings.

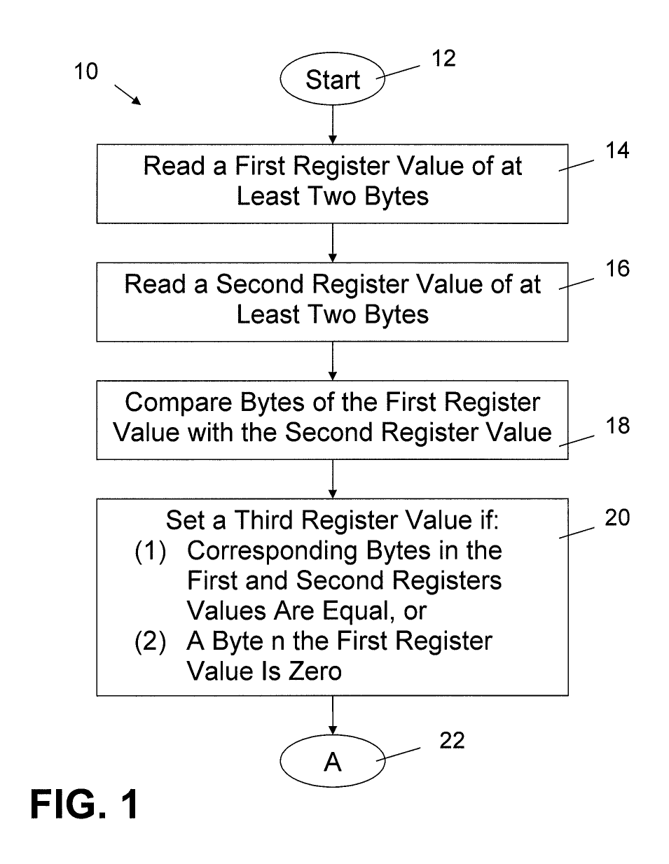

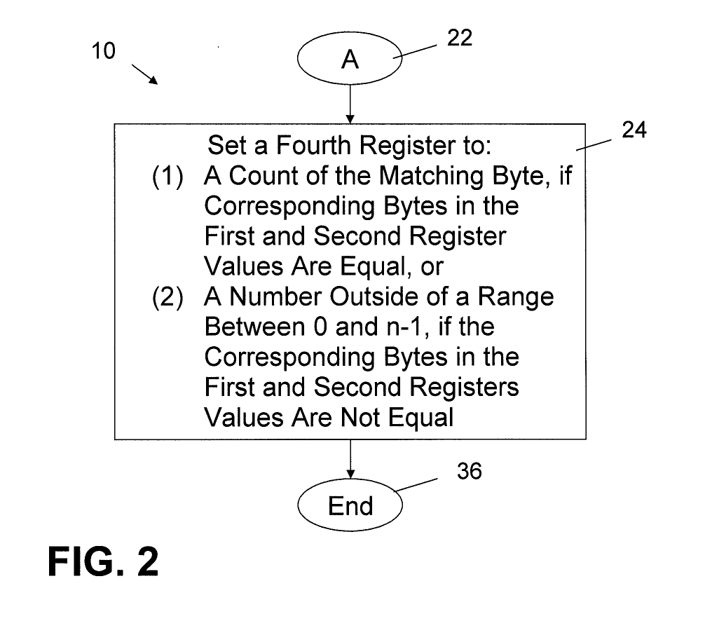

The invention presents a method 10 executed that is executable by a processor. The method 10 is illustrated in FIGS. 1 and 2.

The method 10 begins at 12. At 14, the method 10 reads a first register value of at least two bytes in length. At 16, the method 10 reads a second register value, also of at least two bytes in length. The method 10 contemplates that the first register value and the second register value will both be of the same length, which facilitates the next operation at 18. At 18, the method 10 compares the bytes of the first register value with the bytes of the second register value. At 20, a third register is set to indicate a match if at least one of two conditions are satisfied. First, if a byte in the first register value is equal to a corresponding byte in the second register value, the third register will indicate a match. Second, if a byte in the first register value is zero, the third register will indicate a match. The reference numeral 22 indicates a connector, A, between FIG. 1 and FIG. 2.

The method 10 continues in FIG. 2. At 24, the method 10 proceeds to set a fourth register value depending on one of two conditions. First, the fourth register value is set to a count of the matching byte, if the byte in the first register value is equal to the corresponding byte in the second register value. Second, the fourth register value is set to a number outside of a range of values comprising numbers between 0 and n−1, if the byte in the first register value is not equal to the corresponding byte in the second register value. For the method 10, n is an integer corresponding to the number of bytes in the first and second register values. The method 10 ends at 26.

In one variation of the method 10, the bytes of the first register value and the second register value are compared from the most significant byte to the least significant byte, if the processor is big-endian. In another variation, the bytes of the first register value and the second register value are compared from the least significant byte to the most significant byte, if the processor is little-endian.

With respect to the third register, one embodiment of the invention involves the third register being a condition flag register with one bit. Other variations are also contemplated. For example, the third register may be a condition register with a plurality of bits. In this instance, one of the bits of the third register may be set to indicate the match. Also, it is contemplated that the third register may be a condition register comprising a plurality of bits. In this variation, the third register may retain different values depending on whether the byte in the first register value is equal to the corresponding byte in the second register value or the first byte in the first register value is zero.

With respect to the fourth register value, it is contemplated that the fourth register value may be set to −1, if the byte in the first register value is not equal to the corresponding byte in the second register value. The value, −1, clearly falls outside of the range of values from 0 to n−1. Other variations also are contemplated to fall within the scope of the invention, since −1 is not the only value that may be selected.

In one contemplated variation of the invention, the third register and the fourth register values may be set simultaneously.

In still another variation, it is contemplated that at least two separate registers may cooperate with the processor to execute the method.

In the method 10, it is contemplated that the processor may load into a register beginning with a predetermined byte boundary.

In another variation, the bytes of the first register value are compared with only the lowest bytes of the second register value.

In still one further variation, the method 10 may include additional operations. For example, the method 10 may include modifying the third register if a match is not indicated.

In another embodiment of the invention, the third register may be a condition flag register including one bit. In this embodiment, the bit may be set when the match is indicated. Alternatively, the bit may be cleared when the match is not indicated.

The method 10 of the invention also may operate such that the third register is a condition flag register with one bit. The bit may be cleared when the match is indicated. Alternatively, the bit may be set when the match is indicated.

In another contemplated variation of the method 10, the third register may be a condition register with a plurality of bits. One of the plurality of bits may be set when the match is indicated. Separately, the one bit may be cleared when the match is not indicated.

The third register also may be a condition register with a plurality of bits. In this embodiment, one of the plurality of bits may be cleared when the match is indicated, or the one bit may be set when the match is not indicated.

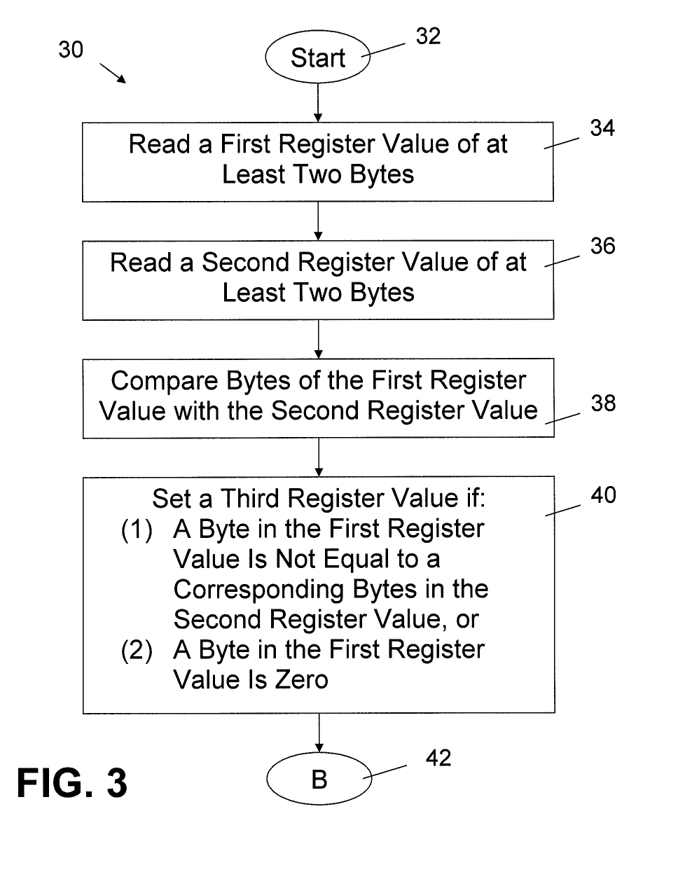

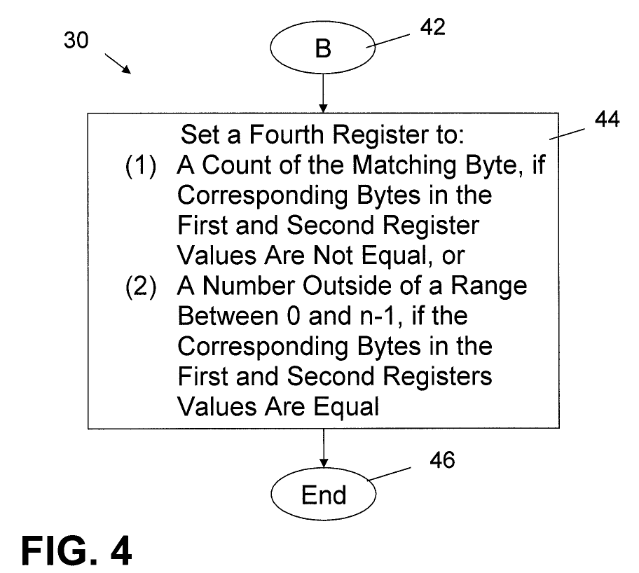

With reference to FIGS. 3 and 4, a second method 30 is described. The method 30 is executable on a processor.

The second method 30 begins at 32. At 34, the method 30 reads a first register value of at least two bytes in length. At 36, the method 30 reads a second register value, also of at least two bytes in length. The method 30 contemplates that the first register value and the second register value will both be of the same length, which facilitates the next operation at 38. At 38, the method 30 compares the bytes of the first register value with the bytes of the second register value. At 40, a third register is set to indicate a match if at least one of two conditions are satisfied. First, if a byte in the first register value is not equal to a corresponding byte in the second register value, the third register will indicate a match. Second, if a byte in the first register value is zero, the third register will indicate a match. The reference numeral 42 indicates a connector, B, between FIG. 3 and FIG. 4.

The method 30 continues in FIG. 4. At 44, the method 30 proceeds to set a fourth register value depending on one of two conditions. First, the fourth register value is set to a count of the matching byte, if the byte in the first register value is not equal to the corresponding byte in the second register value. Second, the fourth register value is set to a number outside of a range of values comprising numbers between 0 and n−1, if the byte in the first register value is equal to the corresponding byte in the second register value. For the method 10, n is an integer corresponding to the number of bytes in the first and second register values. The method 30 ends at 46.

In one variation of the method 30, the bytes of the first register value and the second register value are compared from the most significant byte to the least significant byte, if the processor is big-endian. In another variation, the bytes of the first register value and the second register value are compared from the least significant byte to the most significant byte, if the processor is little-endian.

With respect to the third register in the method 30, the third register may be a condition flag register with one bit. Other variations are also contemplated. For example, the third register may be a condition register having a plurality of bits. In this instance, one of the bits of the third register may be set to indicate the match. Also, it is contemplated that the third register may be a condition register with a plurality of bits. In this variation, the third register may retain different values depending on whether the byte in the first register value is equal to the corresponding byte in the second register value or the first byte in the first register value is zero.

With respect to the fourth register value, it is contemplated that the fourth register value may be set to −1 if the byte in the first register value is not equal to the corresponding byte in the second register value. The value, −1, clearly falls outside of the range of values from 0 to n−1. Other variations also are contemplated to fall within the scope of the invention, since −1 is not the only value that may be selected.

In one contemplated variation of the method 30, the third register and the fourth register values may be set simultaneously.

In still another variation, it is contemplated that at least two separate registers may cooperate with the processor to execute the method.

In the method 30, it is contemplated that the processor may load into a register beginning with a predetermined byte boundary.

In another variation of the method 30, the bytes of the first register value are compared with only the lowest bytes of the second register value.

In still one further variation, the method 30 may include additional operations. For example, the method 30 may include modifying the third register if a match is not indicated.

In another embodiment of the method 30, the third register may be a condition flag register including one bit. In this embodiment, the bit may be set when the match is indicated. Alternatively, the bit may be cleared when the match is not indicated.

The method 30 of the invention also may operate such that the third register is a condition flag register with one bit. The bit may be cleared when the match is indicated. The bit may be set when the match is indicated.

In another contemplated variation of the method 30, the third register may be a condition register with a plurality of bits. One of the plurality of bits may be set when the match is indicated. The one bit may be cleared when the match is not indicated.

Alternatively, the third register may be a condition register with a plurality of bits. In this embodiment, one of the plurality of bits may be cleared when the match is indicated and the one bit may be set when the match is not indicated.

As should be apparent from the foregoing discussion and from the drawings of the invention, the invention is not intended to be limited solely to the embodiments described herein. To the contrary, as should be apparent to those skilled in the art, numerous additional embodiments, variations, and equivalents may be employed without departing from the scope of the invention.

What is claimed is:

1. A method executed by a processor, comprising:
reading a first register value, wherein the first register value comprises at least two bytes;
reading a second register value, wherein the second register value comprises at least two bytes,
wherein the first register value and the second register value both comprise the same number of bytes;
comparing the bytes of the first register value with the bytes of the second register value;
setting a third register to indicate a match if
(1) a byte in the first register value is equal to a corresponding byte in the second register value, or
(2) if a byte in the first register value is zero; and
setting a fourth register value to
(1) a count of the matching byte, if the byte in the first register value is equal to the corresponding byte in the second register value, or
(2) a number outside of a range of values comprising numbers between 0 and n−1, if the byte in the first register value is not equal to the corresponding byte in the second register value,
wherein n is an integer corresponding to the number of bytes in the first and second register values.

2. The method of claim 1, wherein the bytes of the first register value and the second register value are compared from the most significant byte to the least significant byte, if the processor is big-endian.

3. The method of claim 1, wherein the bytes of the first register value and the second register value are compared from the least significant byte to the most significant byte, if the processor is little-endian.

4. The method of claim 1, wherein the third register is a condition flag register comprising one bit.

5. The method of claim 1, wherein:
the third register is a condition register comprising a plurality of bits, and
one bit of the third register is set to indicate the match.

6. The method of claim 1, wherein:
the third register is a condition register comprising a plurality of bits, and
the third register is set to a first match value when a determination is made that a byte in the first register value is equal to a corresponding byte in the second register value, otherwise the third register is set to a second match value when a byte in the first register value is zero.

7. The method of claim 1, wherein the fourth register value is set to −1, if the byte in the first register value is not equal to the corresponding byte in the second register value.

8. The method of claim 1, wherein the third register and the fourth register values are set simultaneously.

9. The method of claim 1, wherein at least two separate registers cooperate with the processor to execute the method.

10. The method of claim 1, wherein the processor loads into a register beginning with a predetermined byte boundary.

11. The method of claim 1, wherein the bytes of the first register value are compared with only the lowest bytes of the second register value.

12. The method of claim 1, further comprising:
modifying the third register if a match is not indicated.

13. The method of claim 12, wherein:
the third register is a condition flag register comprising one bit,
the bit is set when the match is indicated, and
the bit is cleared when the match is not indicated.

14. The method of claim 12, wherein:
the third register is a condition flag register comprising one bit,
the bit is cleared when the match is indicated, and
the bit is set when the match is indicated.

15. The method of claim 12, wherein:
the third register is a condition register comprising a plurality of bits,
one of the plurality of bits is set when the match is indicated, and
the one bit is cleared when the match is not indicated.

16. The method of claim 12, wherein:
the third register is a condition register comprising a plurality of bits,
one of the plurality of bits is cleared when the match is indicated, and
the one bit is set when the match is not indicated.

17. A method executed by a processor, comprising:
reading a first register value, wherein the first register value comprises at least two bytes;
reading a second register value, wherein the second register value comprises at least two bytes,
wherein the first register value and the second register value both comprise the same number of bytes;
comparing the bytes of the first register value with the bytes of the second register value;
setting a third register to indicate a match if
(1) a byte in the first register value is not equal to a corresponding byte in the second register value, or
(2) if a byte in the first register value is zero; and
setting a fourth register value to
(1) a count of the matching byte, if the byte in the first register value is not equal to the corresponding byte in the second register value, or
(2) a number outside of a range of values comprising numbers between 0 and n−1, if the byte in the first register value is equal to the corresponding byte in the second register value,
wherein n is an integer corresponding to the number of bytes in one of either the first and second registers.

18. The method of claim 17, wherein the bytes of the first register value and the second register value are compared from the most significant byte to the least significant byte, if the processor is big-endian.

19. The method of claim 17, wherein the bytes of the first register value and the second register value are compared from the least significant byte to the most significant byte, if the processor is little-endian.

20. The method of claim 17, wherein the third register is a condition flag register comprising one bit.

21. The method of claim 17, wherein:
the third register is a condition register that comprises a plurality of bits, and
one bit of the third register is set to indicate the match.

22. The method of claim 17, wherein:
the third register is a condition register comprising a plurality of bits, and
the third register is set to a first match value when a determination is made that a byte in the first register value is not equal to a corresponding byte in the second register value, otherwise the third register is set to a second match value when a byte in the first register value is zero.

23. The method of claim 17, wherein the fourth register value is set to −1, if the byte in the first register value is not equal to the corresponding byte in the second register value.

24. The method of claim 17, wherein the third register and the fourth register values are set simultaneously.

25. The method of claim 17, wherein at least two separate registers cooperate with the processor to execute the method.

26. The method of claim 17, wherein the processor loads into a register beginning with a predetermined byte boundary.

27. The method of claim 17, wherein the bytes of the first register value are compared only with the lowest bytes of the second register value.

28. The method of claim 17, further comprising:
modifying the third register if a match is not indicated.

29. The method of claim 28, wherein:
the third register is a condition flag register comprising one bit,
the bit is set when the match is indicated, and
the bit is cleared when the match is not indicated.

30. The method of claim 28, wherein:
the third register is a condition flag register comprising one bit,
the bit is cleared when the match is indicated, and
the bit is set when the match is indicated.

31. The method of claim 28, wherein:
the third register is a condition register comprising a plurality of bits,
one of the plurality of bits is set when the match is indicated, and
the one bit is cleared when the match is not indicated.

32. The method of claim 28, wherein:
the third register is a condition register comprising a plurality of bits,
one of the plurality of bits is cleared when the match is indicated, and
the one bit is set when the match is not indicated.
